(19) United States
(12) Patent Application Publication
(10) Pub. No.: US 2026/0008084 A1
(43) Pub. Date: Jan. 8, 2026

(54) MONITORED AND CONTROLLED PLASMA WASTE STREAM ABATEMENT APPARATUS AND METHOD OF USE THEREOF

(71) Applicants: W. Davis Lee, Rockport, ME (US); Mark Amato, S. Hamilton, MA (US)

(72) Inventors: W. Davis Lee, Rockport, ME (US); Mark Amato, S. Hamilton, MA (US)

(21) Appl. No.: 19/207,885

(22) Filed: May 14, 2025

Related U.S. Application Data
(60) Provisional application No. 63/666,907, filed on Jul. 2, 2024.

(51) Int. Cl. B09B 3/50; B01D 53/30; B01D 53/32; B01D 53/34; B01D 53/76; B09B 3/70

(52) U.S. Cl. CPC B09B 3/50; B01D 53/30; B01D 53/32; B01D 53/346; B01D 53/76; B09B 3/70; B01D 2259/818

(57) ABSTRACT

The invention comprises an apparatus and/or a method of use thereof for breaking down a waste product in a plasma, comprising the steps of: inputting the waste product through an input line into a plasma housing, the plasma housing containing the plasma; breaking down the waste product into chemical breakdown products in the plasma; generating, with a first sensor, a first signal related to the chemical breakdown products; and controlling, with a main controller provided the first signal, timing of release of the chemical breakdown products from the plasma housing, such as with the optional steps of: detecting, with a spectrometer emission lines originating within the plasma housing and/or generating, with a residual gas analyzer, a signal related to the chemical breakdown products.

### CROSS-REFERENCES TO RELATED APPLICATION

This application claims the benefit of U.S. provisional patent application No. 63/666,907 filed Jul. 2, 2024, all of which is incorporated herein in its entirety by this reference thereto.

### BACKGROUND OF THE INVENTION

### Field of the Invention

The invention relates generally to a monitored and controlled plasma waste stream abatement system.

### Discussion of the Prior Art

### Problem

There exists in the art a need to monitor and/or neutralize waste stream output.

### SUMMARY OF THE INVENTION

The invention comprises a monitored and controlled plasma waste stream abatement apparatus and method of use thereof.

### DESCRIPTION OF THE FIGURES

A more complete understanding of the present invention is derived by referring to the detailed description and claims when considered in connection with the Figures, wherein like reference numbers refer to similar items throughout the Figures.

FIG. 1 illustrates a waste stream abatement system;

FIG. 2 illustrates a waste stream abatement apparatus;

FIG. 3 illustrates input and output waste stream analyzers;

FIG. 4 illustrates plasma reactor parameters;

FIG. 5 illustrates classes of analyzers; and

FIG. 6A and FIG. 6B illustrate upstream and downstream analyzer data, respectively.

Elements and steps in the figures are illustrated for simplicity and clarity and have not necessarily been rendered according to any particular sequence. For example, steps that are performed concurrently or in different order are illustrated in the figures to help improve understanding of embodiments of the present invention.

### DETAILED DESCRIPTION OF THE INVENTION

The invention comprises an apparatus and/or a method of use thereof for breaking down a waste product in a plasma, comprising the steps of: inputting the waste product through an input line into a plasma housing, the plasma housing containing the plasma; breaking down the waste product into chemical breakdown products in the plasma; generating, with a first sensor, a first signal related to the chemical breakdown products; and controlling, with a main controller provided the first signal, timing of release of the chemical breakdown products from the plasma housing, such as with the optional steps of: detecting, with a spectrometer emission lines originating within the plasma housing and/or generating, with a residual gas analyzer, a signal related to the chemical breakdown products.

Herein, a z-axis is aligned with gravity and an x/y-plane is perpendicular to the z-axis, such as a floor surface.

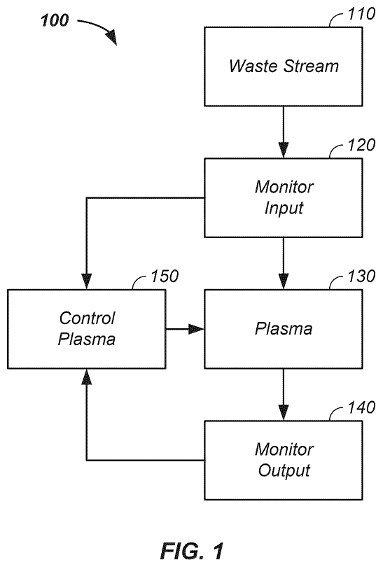

Referring now to FIG. 1, a waste stream abatement system 100 is illustrated. Generally, the waste stream 110 is any waste stream. Herein, for clarity of presentation and without loss of generality, chemical disposal examples of the waste stream 110 are presented. Generally, a first process of monitoring input 120 of the waste stream 110 is performed, which yields input on particular chemicals/chemical classes present in the waste stream along with concentration information. In a second process, the waste stream 110 is processed/abated by plasma 130, which breaks apart chemical bonds forming notably less toxic chemicals/substances. A third process of monitoring output 140 from the plasma 130 yields information on success of the abatement process. Output for the input monitoring system 120 and/or the output monitoring system 140 is optionally and preferably used in a process of controlling the plasma 150, such as via use of a main controller/computer.

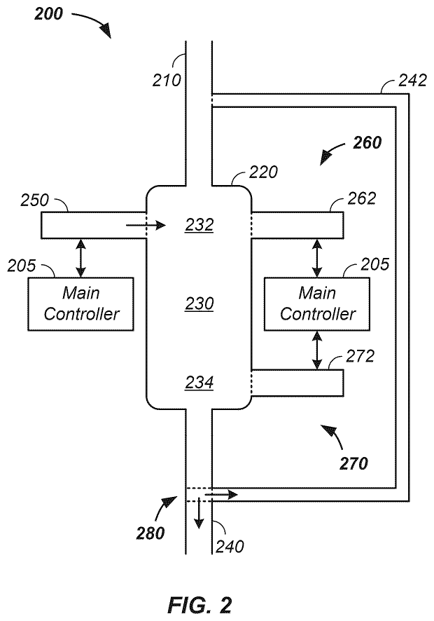

Referring now to FIG. 2, a waste stream abatement apparatus 200 is illustrated. Generally, an input line 210 carries the waste stream 110 into a plasma housing 220 containing the plasma 130, such as in a reaction zone/abatement zone 230. An exit line 240 carries residuals from the abatement zone 230 out of the waste stream abatement system 100.

Still referring to FIG. 2, generally a main controller 205 is used to control the plasma 130, such as through control of process chemicals 250 input into the plasma housing 220 and/or through control of temperature and pressure in the plasma container, as further described infra.

Still referring to FIG. 2, optionally and preferably analyzers/sensors are used to monitor the waste stream, such as use of: (1) one or more input analyzers 260, positioned proximate an entry point of the waste stream 110 into the plasma container 220, and/or (2) one or more output analyzers 270, positioned proximate an exit point of the waste stream 110 from the plasma container 220 into the exit line 240. Herein, proximate position refers to a position less than 1, 2, 3, 4, 5, 7.5, 10, 15, 25, or 50 inches of the referenced position. Two examples are provided to illustrate monitors in the plasma container, infra.

### Example I

Still referring to FIG. 2, an internal input analyzer 262 is illustrated. Generally, the internal input analyzer 262 is used to analyze the waste stream 110 within the plasma container 220 proximate an input zone 232 in the plasma 130. While the internal input analyzer 262 is optionally any form of analyzer/spectrometer, an emission spectrometer is optionally and preferably preferred as the plasma functions as a source. For instance, spectroscopic emission lines are observed and related to particular elements, chemical states, molecular bonds, and/or collections of bonds. Similarly, a mass spectrometer, such as a residual gas analyzer, is optionally used to measure masses and/or charges of chemical species present in the plasma 230 near the input stream input zone 232. The input analyzers 260 are useful for: (1) identifying chemical classes, (2) confirming chemical classes, and/or (3) calculating concentration of chemical classes present in the waste stream 110 and/or for controlling state of the plasma 130 based on results generated using data from the input analyzer(s) 260.

### Example II

Still referring to FIG. 2, an internal output analyzer 272 is illustrated. Generally, the internal output analyzer 272 is used to analyze the waste stream 110 within the plasma container 220 proximate an output zone 234 in the plasma 130. While the internal output analyzer 272 is optionally any form of analyzer/spectrometer, an emission spectrometer, such as a second emission spectrometer, is optionally and preferably preferred as the plasma functions as a source. For instance, spectroscopic emission lines are observed and related to particular elements, chemical states, molecular bonds, and/or collections of bonds. Similarly, a mass spectrometer, such as a residual gas analyzer or second mass spectrometer, is used to measure masses and/or charges of chemical species present in the plasma 230 near an output zone 234 of the plasma 130. The output analyzers 270 are useful for: (1) identifying chemical classes, (2) confirming chemical classes, and/or (3) calculating concentration of chemical classes present in the waste stream 110 and/or for controlling state of the plasma 130 based on results generated using data from the output analyzer(s) 270. The output analyzer(s) 270 are particularly useful for confirming abatement of the waste stream, such as on an individual chemical basis, and/or for use in a decision of altering a valve position of an output valve 280 to redirect the output waste stream through a return line 242 to the input line 210/input stream for further processing/abatement and/or simply to maintain the chemicals in the plasma 130 for a longer time period, such as by shutting an exit valve to the plasma container 220.

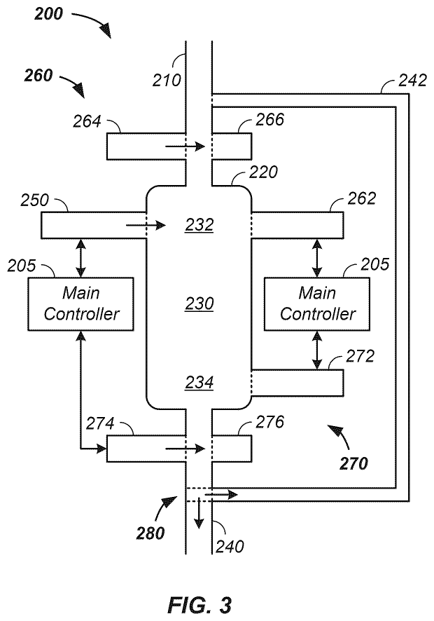

Referring now to FIG. 3, the input analyzer(s) 260 and output analyzer(s) are further described. Optionally, the input analyzer(s) 260 include an external input analyzer 264, such as a transmission analyzer using a first detector 266. The external input analyzer 264 allows for analysis of a gas, liquid, or solid waste stream using any analytical technique. Similarly, the output analyzer(s) 270 optionally include an external output analyzer 274, such as a second transmission analyzer using a second detector 276. The external output analyzer 274 allows for analysis of a gas, liquid, or solid waste stream using any analytical technique. Generally, any of the analyzers described herein use any chemical and/or physical technique, such as further described infra.

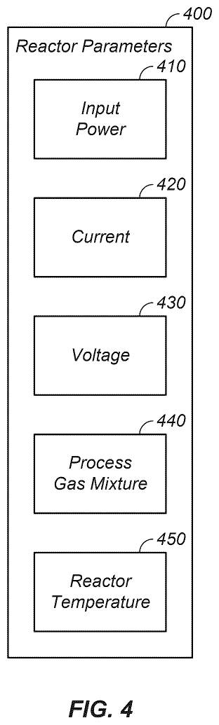

Referring now to FIG. 4, reactor parameters 400 for use in operation/control of the plasma 130 are described. Generally, the reactor parameters 400 are controlled by the main controller 205, such as in a preprogrammed manner and/or preset manner, but optionally and preferably based upon provided information about contents of the waste stream 110 and/or any input from the input analyzers 260 and/or output analyzers 270. Examples of reactor parameters include one or more of: input power 410, current 420, voltage 430, a process gas mixture 440, and/or reactor temperature 450.

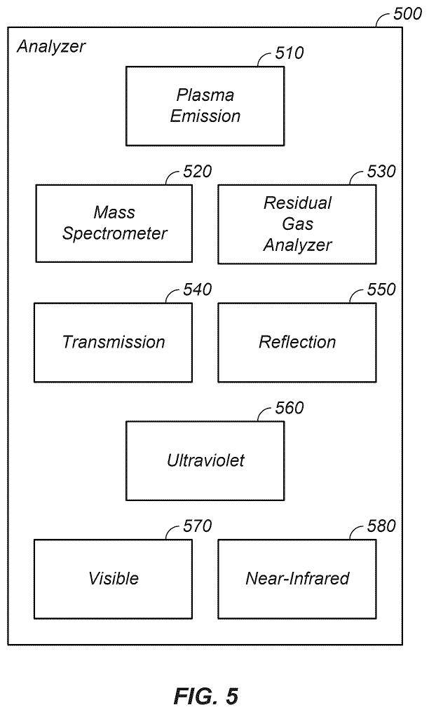

Referring now to FIG. 5, analyzers 500 are further described. While any chemical and/or physical process is optionally measured with the analyzer 500, some optional and preferred analyzer types include one or more of: plasma emission 510, mass spectrometer 520, residual gas analyzer 530, transmission 540, reflection 550, ultraviolet 560, visible 570, and/or near-infrared 580 analyzers/spectrometers.

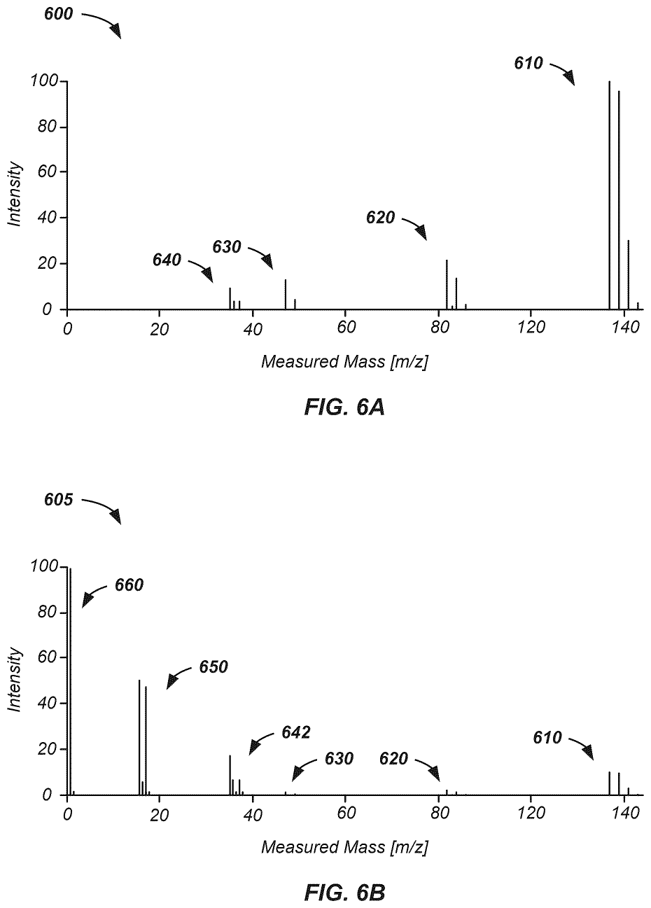

Referring again to FIG. 2 and referring now to FIGS. 6A and 6B, an example of pre- and post-abatement processing is provided, which is a goal of the waste stream abatement system 100. In this simple example, carbon tetrachloride is the only liquid/gas present in the waste stream. An input analyzer 260, such as a residual gas analyzer positioned proximate to the analyzer input zone 232 in the plasma 130 yields a mass spectrum provided in FIG. 6A. Analysis of the charge-to-mass ratios of the detected carbon tetrachloride 600, CCl₄, yields peaks/groupings related to CCl₃ 610, CCl₂ 620, CCl 630, and Cl 640 ions with various isotopes in each grouping. The peaks confirm presence of carbon tetrachloride in the waste stream 110 and is optionally used to determine a concentration of the carbon tetrachloride, such as in the input zone 232 in the plasma container 220. Referring now to FIG. 6B, output of a residual gas analyzer positioned near the output zone 234 in the plasma container 220 shows about a 90 percent reduction in the CCl₃ 610, CCl₂ 620, CCl 630 ions. Based on this, the main controller 205 directs continued processing in the plasma 130, redirection of the output back into the plasma 130, as describe supra, and/or release of the output stream. Analysis of the charge-to-mass ratios of the detected carbon tetrachloride 600 yields peaks/groupings related to CCl₃ 610, CCl₂ 620, CCl 630, and Cl 640 ions with various isotopes in each grouping. For CClₙ, where n is 1, 2, and/or 3, one example of a monitoring ratio is for a CClₙ-to-CCl₄ ratio to be larger than 1:1, 5:1, 10:1, 25:1, 50:1, or 100:1. Those skilled in the art will understand that more complex waste streams are similarly abated, analyzed, monitored, and/or processed. For example, the waste stream abatement system is readily applied to waste products comprising: a chlorofluorocarbon, a chlorocarbon, a fluorocarbon, carbon tetrafluoride, carbon tetrachloride, a forever chemical, and/or a perfluoroalkyl substance/a polyfluoroalkyl substance (PFAS).

Still referring to FIG. 6A and FIG. 6B, generally, a mass spectrum from a residual gas analyzer plots intensity versus a measured mass-to-charge ratio. In the breakdown process described herein, an initial chemical in the waste process has the largest charge to mass ratio, such as soon as protonated or stripped of a proton. As the largest peak, with the initial largest mass-to-charge ratio, shrinks with breakdown of the chemical, peaks with smaller mass-to-charge ratios grow. Thus, a ratio of a first intensity as a lower charge-to-mass ratio to a second intensity of the initial largest charge-to-mass ratio is a measure of breakdown progress of the chemical in the plasma, such as ratios of 1-to-1, 2-to-1, 5-to-1, 10-to-1 indicating progressively more breakdown of the original chemical in the waste stream.

Still yet another embodiment includes any combination and/or permutation of any of the elements described herein.

Herein, any number, such as 1, 2, 3, 4, 5, is optionally more than the number, less than the number, or within 1, 2, 5, 10, 20, or 50 percent of the number.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. A method for breaking down a waste product in a plasma, comprising the steps of:
inputting the waste product through an input line into a plasma housing, said plasma housing containing the plasma;
breaking down the waste product into chemical breakdown products in the plasma;
generating, with a first sensor, a first signal related to the chemical breakdown products; and
controlling, with a main controller provided the first signal, timing of release of the chemical breakdown products from said plasma housing.

2. The method of claim 1, further comprising the step of:
detecting, with a spectrometer comprising the first sensor, emission lines originating within said plasma housing.

3. The method of claim 2, further comprising the step of:
generating, with a residual gas analyzer, a second signal related to the chemical breakdown products.

4. The method of claim 3, said step of controlling further comprising the steps of:
communicating the second signal to said main controller; and
opening a valve based on a communication from said main controller, said valve connected to an output line from said plasma housing.

5. The method of claim 4, further comprising the steps of:
positioning said spectrometer to optically couple to a first detection zone in said plasma housing; and
coupling said residual gas analyzer to a second detection zone in said plasma housing, the input line closer to said first detection zone than said second detection zone.

6. The method of claim 4, further comprising the steps of:
determining a ratio of a first peak height of the second signal related to CClₙ, where n is less than four, to a second peak height of the second signal related to CCl₄; and
directing said step of opening when said ratio is greater than five-to-one.

7. The method of claim 4, further comprising the step of:
determining a first intensity of a largest charge-to-mass ratio output from a mass spectrum output of said residual gas analyzer;
determining a second intensity of a second charge-to-mass ratio output from the mass spectrum of said residual gas analyzer, said second charge-to-mass ratio less than fifty percent of said largest charge-to-mass ratio output; and
said step of controlling further comprising the step of terminating said step of breaking down when a ratio of said second intensity-to-said first intensity exceeds five-to-one.

8. The method of claim 1, said step of controlling further comprising the step of:
monitoring formation of hydrogen fluoride from boron trifluoride in the plasma, the boron trifluoride in the waste product.

9. The method of claim 1, further comprising the step of:
adjusting, based on the first signal with said main controller, a power applied to the plasma, in terms of an applied current and an applied voltage.

10. The method of claim 9, further comprising the steps of:
generating, with a second sensor, a second signal related to the chemical breakdown products;
sensing a reaction zone within said plasma housing with said first signal; and
sensing an output zone of the breakdown product downstream from said reaction chamber with said second signal.

11. The method of claim 10, further comprising the steps of:
generating the first signal with a first residual gas analyzer; and
generating the second signal with a second residual gas analyzer.

12. The method of claim 1, further comprising the steps of:
monitoring abatement of the waste product in said plasma housing with a first spectrometer, configured to generate the first signal; and
generating a second signal, sent to said main controller, with a first residual gas analyzer configured to monitor abatement of the waste product in said plasma housing.

13. The method of claim 12, further comprising the step of:
generating third signal, sent to said main controller, with a second residual gas analyzer configured to monitor an output stream of residuals of the waste product in an exit line from said plasma housing.

14. An apparatus configured to break down a waste product in a plasma, comprising:
an input line configured to carry the waste product into a plasma housing, said plasma housing configured to contain the plasma during use, the plasma configured to break down the waste product into chemical breakdown products in the plasma;
a first sensor configured to generate a first signal related to the chemical breakdown products; and
a main controller, provided the first signal, configured to control timing of release of the chemical breakdown products from said housing.

15. The apparatus of claim 14, further comprising:
an exit line from said plasma housing;
a return line from said exit line to said input line; and
a valve controlling flow from said exit line to said return line under control of said main controller.

16. The apparatus of claim 15, further comprising:
a second sensor configured to generate a second signal related to the chemical breakdown products in said exit line, said second signal conveyed to said main controller.

17. The apparatus of claim 16, further comprising:
an emission spectrometer comprising said first sensor, said first sensor coupled to a breakdown zone in said plasma housing.

18. The apparatus of claim 16, further comprising:
a first residual gas analyzer comprising said first sensor, said first sensor coupled to a breakdown zone in said plasma housing.

19. The apparatus of claim 18, further comprising:
a second residual gas analyzer comprising said second sensor.

20. The apparatus of claim 18, further comprising:
a spectrometer comprising said second sensor.
